(19) United States
(12) Patent Application Publication
(10) Pub. No.: US 2004/0053536 A1
(43) Pub. Date: Mar. 18, 2004

(54) Plug device

(75) Inventors: Cheng-Chuan Chen, Taipei (TW); Yau-Fu Wang, Taipei (TW)

Correspondence Address: TROXELL LAW OFFICE PLLC, SUITE 1404, 5205 LEESBURG PIKE, FALLS CHURCH, VA, 22041, US

(73) Assignee: PHIHONG ENTERPRISE CO., LTD.

(21) Appl. No.: 10/369,652

(22) Filed: Feb. 21, 2003

(30) Foreign Application Priority Data
Sep. 17, 2002 (TW) 091214683

(51) Int. Cl. H01R 25/00; H01R 27/02

(52) U.S. Cl. 439/638

(57) ABSTRACT

A plug device has conductive blades located on the front end of the plug. The conductive blades may be turned into a trough of the plug by means of a linkage means. When not in use, the conductive blades may be retracted easily in the plug to facilitate storage and reducing the thickness.

### BACKGROUND OF THE INVENTION

1. Field of the Invention

The invention relates to a plug device that has a linkage means to turn conductive blades located at the front end of the plug into a trough of the plug to facilitate storage and reduce thickness.

2. Description of the Prior Art

Conventional plug devices for general home appliances are constructed like the one shown in FIG. 1 that has conductive blades 10 inserted into a plug body. The plug is bulky and the conductive blades are fixedly mounted. It is difficult to store.

FIG. 2A illustrates another conventional plug devices that is rotary (referring to Japan patent publication No. 11-224717). It includes a conductive blade set 20 located in the plug. The conductive blade set 20 has a first rotary axle 22 and a second rotary axle 24 that may be held in a rotary trough 28 and turn freely therein. Inside the plug, there are a first conductive end 26a and a second conductive end 26b to serve as two poles of AC power supply to connect respectively two ends of the conductive blade set 20. FIG. 2B shows the plug in a use condition. The front end 21 of the conductive blade is turned outwards. When there is a desire to retract to plug, the first rotary axle 22 and the second rotary axle 24 may be turned to move the front end 21 of the conductive blade of the conductive blade set 20 into the plug. While it is less bulky, the thickness has not been reduced very much.

### SUMMARY OF THE INVENTION

In view of the aforesaid disadvantages, the primary object of the invention is to provide a plug device to facilitate storage and reduce the thickness thereof.

The plug device according to the invention has a linkage means to turn the front end of conductive blades into a rotary trough of the plug and move the conductive blades in the meantime. There are also a plurality of rotary sleeve tenons coupled with an elastic clip and a plurality of conductive blade rotary sleeves with rotary sleeve conductive ends to connect to conductive ends of the casing to enable the conductive blades be retracted easily into the plug. The plug thus constructed may be stored easily and has a smaller thickness.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional plug devices.

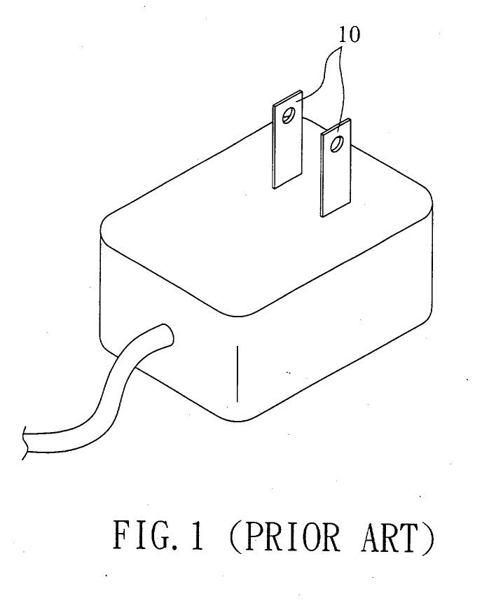

FIG. 2A is a schematic view of a conventional rotary plug devices.

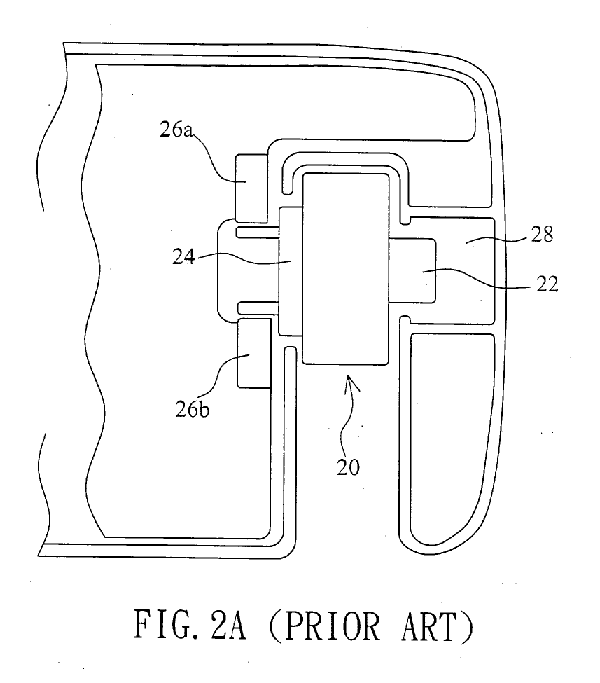

FIG. 2B is a schematic view of the conductive blade set of a conventional rotary plug devices.

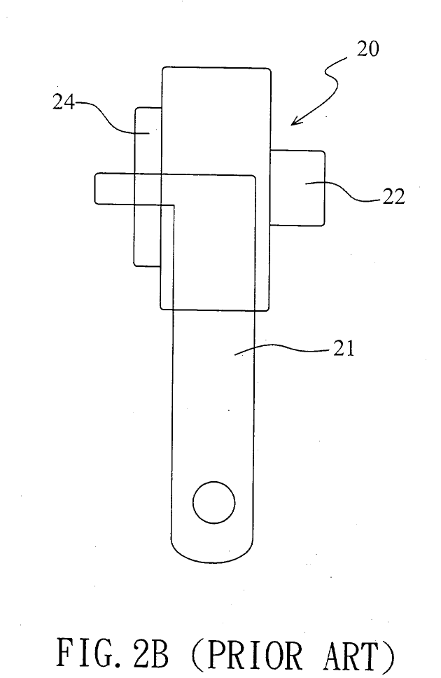

FIG. 3 is an embodiment of the conductive blade set of the plug device of the invention.

FIG. 4A is a side perspective view of an embodiment of the plug device of the invention.

FIG. 4B is a rear perspective view of an embodiment of the plug device of the invention.

FIG. 5 is a perspective view of a second embodiment of the conductive blade set of the invention.

FIG. 6A is a schematic view of an embodiment of the plug device of the invention in a use condition.

FIG. 6B is a schematic view of an embodiment of the plug device of the invention in a turning condition.

FIG. 6C is a schematic view of an embodiment of the plug device of the invention in a folding condition.

### DESCRIPTION OF THE PREFERRED EMBODIMENTS

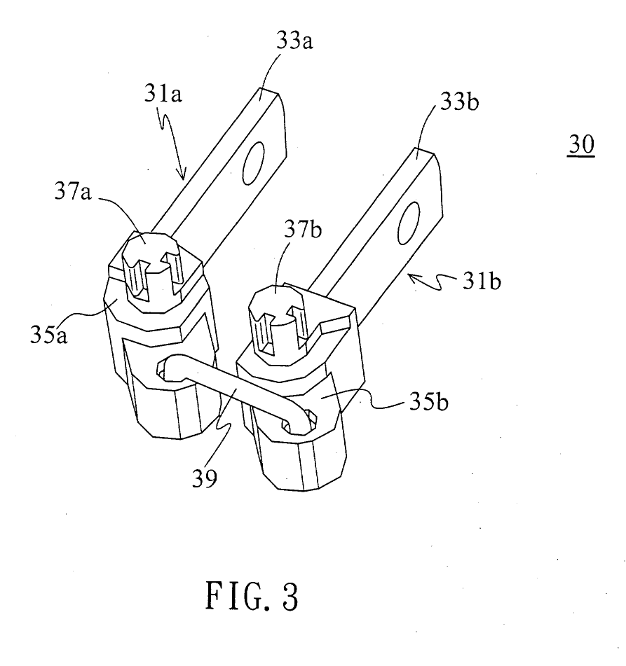

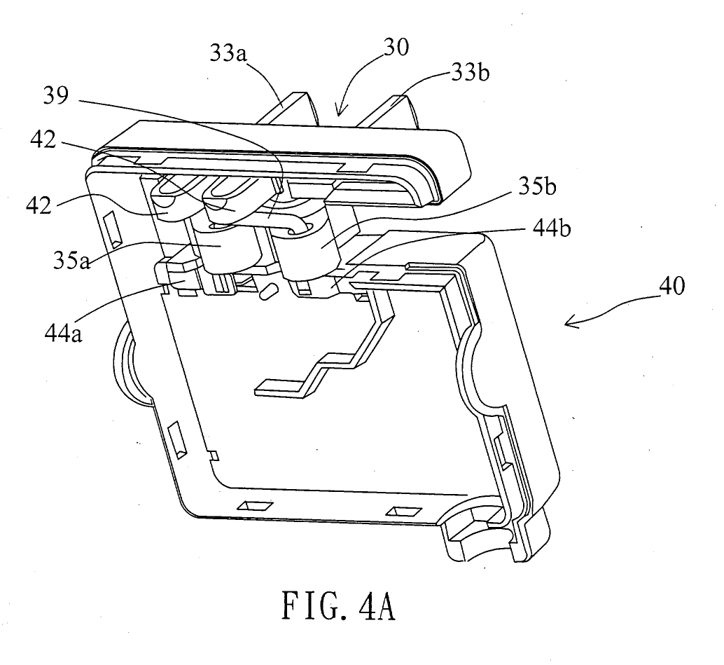

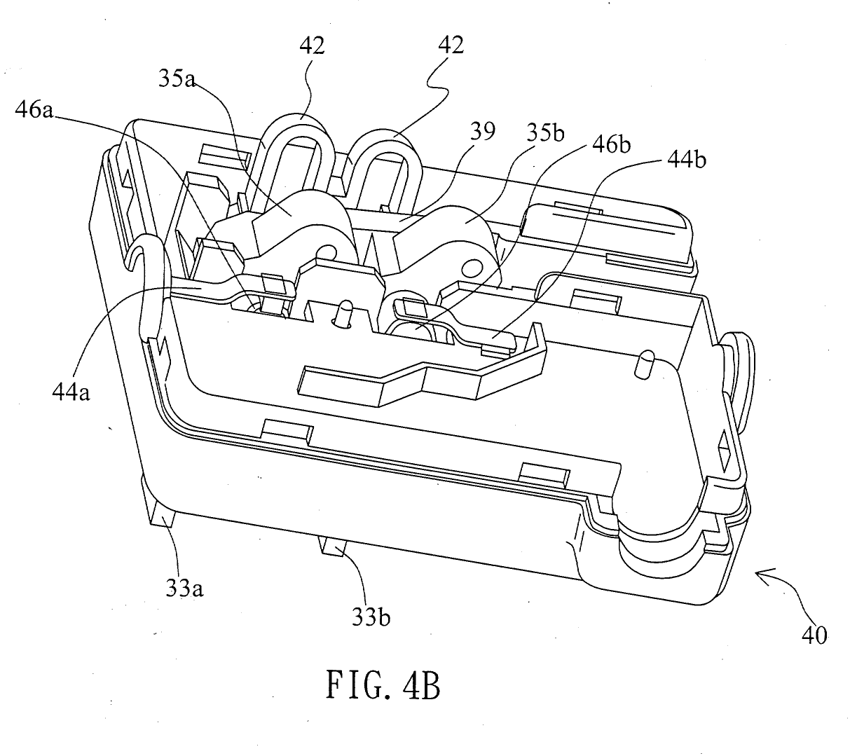

Referring to FIG. 3, the plug device of the invention mainly includes a conductive blade set 30 which has a first conductive blade set 31a and a second conductive blade set 31b arranged in a juxtaposed manner. The first conductive blade set 31a includes a first conductive blade 33a coupled with a first conductive blade rotary sleeve 35a for connecting to a casing. The second conductive blade set 31b includes a second conductive blade 33b coupled with a second conductive blade rotary sleeve 35b for connecting to the casing. The conductive blade rotary sleeves have respectively a trough to couple with a linkage means 39 which connects the first conductive blade set 31a and the second conductive blade set 31b. The first conductive blade rotary sleeve 35a and the second conductive blade rotary sleeve 35b further have respectively a first tenon 37a and a second tenon 37b for anchoring the conductive blade set 30 securely in the casing 40 (details will be discussed later in FIG. 4).

Referring to FIG. 4A, the conductive blade set 30 is housed in the casing 40. The casing 40 also houses a charge circuit to become a compact electric charger for a mobile phone or a personal digital assistant (PDA), or other devices related to portable computers. As shown in FIG. 4A, the conductive blade set 30 is located on one side of the casing 40 to spare a space to house the charge circuit. The first tenon 37a (not shown in the drawing) of the first conductive blade rotary sleeve 35a and the second tenon 37b (also not shown in the drawing) of the second conductive blade rotary sleeve 35b are gripped by an elastic clip 42 which is fixedly mounted in the casing 40. Thus the conductive blade set 30 is also securely held in the casing 40. The tenons 37a and 37b are turnable within a selected elastic range in the elastic clip 42. The lateral side of the conductive blade set 30 may be turned outside the casing 40 when in use, and also may be turned and retracted into the casing 40 when not in use.

Inside the casing 40, there are a first connective end 44a and a second conductive end 44b for connecting two poles of AC power to two ends of the conductive blade set 30. The first connective end 44a and the second conductive end 44b are made from a metal blade, and may contact the first conductive blade rotary sleeve 35a and the second conductive blade rotary sleeve 35b for transmitting AC electricity to the first conductive blade 33a and the second conductive blade 33b.

Referring to FIG. 4B, the first conductive blade rotary sleeve 35a and the second conductive blade rotary sleeve 35b of the conductive blade set 30 are connected to the conductive ends of the casing 40 through a first rotary conductive end 46a and a second rotary conductive end 46b. As the first conductive end 44a and the second conductive end 44b are elastic metal, when the conductive blade set 30 turns, it keeps a tight and movable connection with the rotary conductive ends and still maintains conductivity after turning.

As shown in the drawings, the first conductive blade rotary sleeve 35a and the second conductive blade rotary sleeve 35b of the conductive blade set 30 are linked by the linkage means 39 so that they can be turned at the same time and be clamped by the elastic clip 42. When they are turned into the casing 40, they are retracted to make the thickness of the casing smaller. As shown in FIG. 3, the first tenon 37a and the second tenon 37b are clamped by the elastic clip, so that the first conductive blade rotary sleeve 35a and the second conductive blade rotary sleeve 35b are stationed on fixed locations. Therefore they may be turned 90 degrees when in use and be retracted in the casing 40 when not in use.

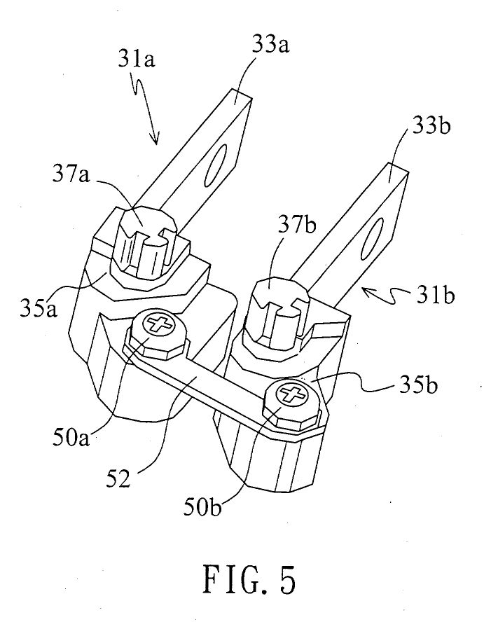

Refer to FIG. 5 for a second embodiment of the conductive blade set of the invention. It is largely constructed as the one shown in FIG. 3, and also includes a first conductive blade set 31a and a second conductive blade set 31b arranged in a juxtaposed manner. The first conductive blade set 31a includes a first conductive blade 33a coupled with a first conductive blade rotary sleeve 35a. The second conductive blade set 31b includes a second conductive blade 33b coupled with a second conductive blade rotary sleeve 35b. The conductive blade rotary sleeves have respectively a first tenon 37a and a second tenon 37b for anchoring the conductive blade set securely in a casing of a plug devices. The first conductive blade set 31a and the second conductive blade set 31b are connected by a linkage bar 52. The linkage bar 52 are fastened to the first conductive blade set 31a and the second conductive blade set 31b by means of a first screw set 50a and a second screw set 50b. The first screw set 50a and the second screw set 50b have respectively a bolt screwed into the first conductive blade rotary sleeve 35a and the second conductive blade rotary sleeve 35b. The connecting portions of the screw sets and the linkage bar 52 are turnable freely to enable the plug of the invention to achieve the desired object.

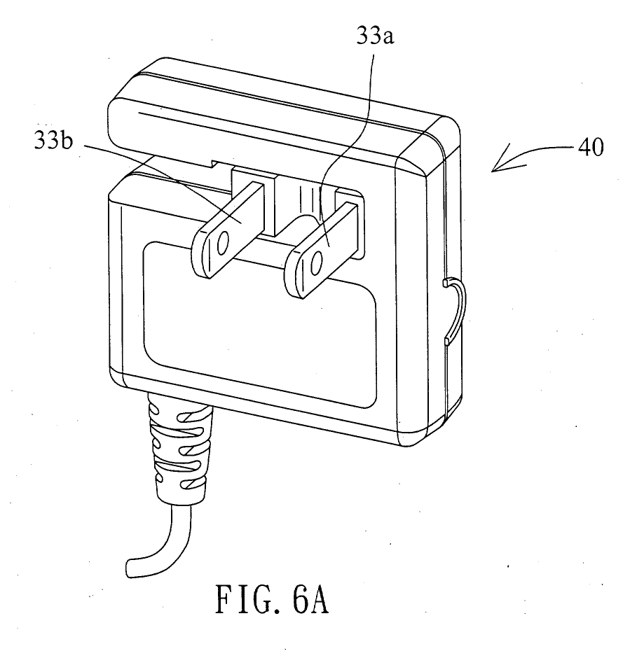

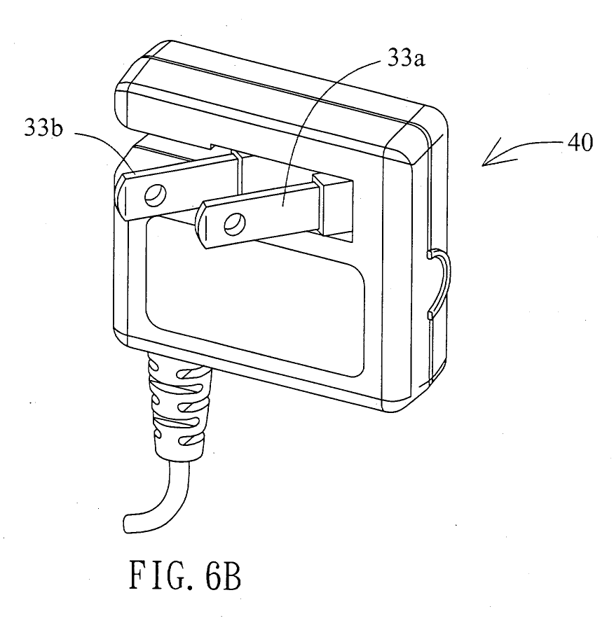

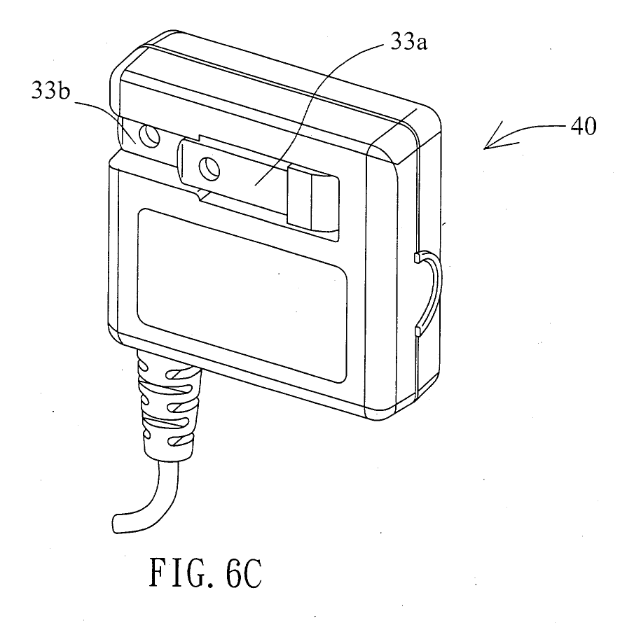

Refer to FIG. 6A for the invention in a use condition. The first conductive blade 33a and the second conductive blade 33b are turned for 90 degrees outside the casing 40 and are in parallel with the side wall of the casing.

FIG. 6B shows the plug of invention in a turning condition. Due to the linkage means mentioned above, the first conductive blade 33a and the second conductive blade 33b have respectively their own pivotal axis and may be turned about the axis in parallel.

FIG. 6C shows the plug of invention in a retracted condition. The first conductive blade 33a and the second conductive blade 33b may be turned respectively about their own pivotal axis and are retracted in the casing in a staggered manner.

By means of the construction and embodiments set forth above, through a linkage means to connect two ends of the first conductive blade set and the second conductive blade set of the conductive blade set, the plug may be extended for use and retracted for storage easily, and the thickness is also reduced.

While the preferred embodiments of the invention has been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A plug device, comprising:
a plurality of conductive blades for conducting electricity;
a plurality of conductive blade rotary sleeves including a plurality of tenons and a plurality of rotary sleeve conductive ends for coupling with the conductive blades;
a linkage means connecting the conductive blade rotary sleeves;
an elastic clip coupling with the tenons of the conductive blade rotary sleeves to station the tenons and allow the tenons turnable freely therein; and
a plurality of conductive ends located in a casing for connecting to the rotary sleeve conductive ends of the conductive blade rotary sleeves.

2. The plug device of claim 1, wherein the conductive blades, the conductive blade rotary sleeves and the linkage means are assembled to form a conductive blade set.

3. The plug device of claim 1, wherein the elastic clip and the conductive ends are located in the casing.

4. The plug device of claim 1, wherein the linkage means connects the first conductive blade set and the second conductive blade set of the conductive blade set through a trough formed respectively in the conductive blade rotary sleeves.

5. The plug device of claim 1, wherein the conductive ends are movably connected to the rotary sleeve conductive ends.
